(19) United States
(12) Patent Application Publication
(10) Pub. No.: US 2013/0146810 A1
(43) Pub. Date: Jun. 13, 2013

(54) Process for Producing Water-Absorbing Polymer Fibres

(71) Applicant: BASF SE, Ludwigshafen (DE)

(72) Inventors: Xiaomin Zhang, Charlotte, NC (US); Kathleen Goebel, Charlotte, NC (US); Michael A. Mitchell, Waxhaw, NC (US); Thamas Daniel, Waldsee (DE)

(73) Assignee: BASF SE, Ludwigshafen (DE)

(21) Appl. No.: 13/707,226

(22) Filed: Dec. 6, 2012

Related U.S. Application Data
(60) Provisional application No. 61/568,169, filed on Dec. 8, 2011.
(60) Provisional application No. 61/578,949, filed on Dec. 22, 2011.

(51) Int. Cl. B01J 20/30; B01J 20/28

(52) U.S. Cl. CPC B01J 20/3007; B01J 20/28023
USPC 252/194; 264/6; 428/401; 526/317.1

(57) ABSTRACT

The present invention relates to a process for producing water-absorbing polymer fibers, especially micro-or nanofibers, by electrospinning process and to fibers obtainable by this process.

The present invention relates to a process for producing water-absorbing polymer fibers, especially micro-or nanofibers, by electrospinning process and to fibers obtainable by this process.

Water-absorbing polymers (“super absorbent polymer”, SAP) are widely used in sanitary goods and hygiene articles such as disposable diapers, adult incontinence pads and catamenial products as sanitary napkins. Water absorbing resins are available in a variety of chemical forms.

The production of SAP particles is described in the monograph “Modern Superabsorbent Polymer Technology”, F. L. Buchholz and A. T. Graham, Wiley-VCH, 1998, pages 71 to 103.

Much effort is taken to very thin absorbent articles such as diapers, because they fit better and less noticeable and as article packaging is more compact they easier to carry and to store and therefore the distribution costs are reduced. Many attempts in reducing increasing the amount of SAP particles in such products and reduction of fluff are made, but as gel blocking has necessitated the use of a fibrous matrix to disperse the SAP particles and separate the SAP particles from one another the reduction of fluff causes a lot of problems.

To overcome these problems fibrous substrates impregnated with superabsorbent polymers are prepared e. g. U.S. Pat. No. 5,614,296, U.S. Pat. No. 5,980,996 and U.S. Pat. No. 5,756,159 disclose fibrous substrates impregnated with the monomer, which subsequently is polymerized in situ by UV light to form an SAP in contact with the fibrous substrate. But the process is very time consuming and the resulting absorbing sheet is very inflexible, which is difficult to handle without breakage.

The use of nano-or micro-SAP fibers instead of fluff or mixtures of SAP fibers plus fluff may solve the problem. Furthermore there is no need to immobilize particles in fluff-free absorbent cores, to assure a homogeneous distribution.

SAP particles in fiber form are known. For example U.S. Pat. Nos. 5,147,956 and 4,962,172 disclose absorbent products and their method of manufacture. Additional patents include U.S. Pat. No. 3,867,499, U.S. Pat. No. 4,913,869 or U.S. Pat. No. 5,667,743 disclose a wet-laid nonwoven fabric comprising a blend of SAP fibers and less absorbing fiber, like woodpulp. WO 98/24832 discloses an absorbent composition containing an acidic and basic material, which can be in fiber form. Furthermore U.S. Pat. No. 6,332,298 discloses multicomponent superabsorbent fibers comprising at least one acidic water absorbing resin and at least one basic water absorbing resin. The SAP fibers are prepared by extrusion of the rubbery gel of a SAP particles and then dried and optionally surface crosslinked. The resulting fibers are therefore relatively thick.

U.S. Pat. No. 6,342,298 discloses a method for producing multicomponent SAP fibers. The fibers are prepared by gel extrusion or dry or wet spinning. The fibers obtained are of about at least 10 μm up to 1 mm and a length of about 1 mm to 10 mm.

But for use in hygiene articles it is preferred that the fibers have a very high surface area and high fluid absorbency and high fluid retention properties. A very high surface area can be achieved with fibers in the nano- or micro-range. Fibers in this range can be produced with electrospinning.

The preparation of polymer fibers, especially nano- and mesofibers by the electrospinning process is well described in various documents.

The process is e.g. described by D. H. Renecker, H. D. in Nanotech. 7 (1996), page 216 ff. A polymer melt or a polymer solution is typically exposed to a high electrical field at an edge which serves as an electrode. This can be achieved e. g. by extrusion of the polymer melt or polymer solution in an electrical field under low pressure by a cannula connected to one pole of a voltage source. Owing to the resulting electrostatic charge of the polymer melt or polymer solution, there is a material flow directed toward the counterelectrode, which solidifies on the way to the counterelectrode. Depending on the geometry of the electrode nonwovens or assemblies of ordered fibers are obtained by this process.

US 2010/0013126 discloses the electrospinning of at least one essentially water- insoluble polymer and at least one water-soluble polymer, whereas the water-soluble polymer serves as a template, for the water-insoluble polymer, which is removed by washing.

As polyvinyl alcohol, polyvinyl amine, polyethylene oxide, polyvinylpyrrolidone or hydroxypropylcellulose are water-soluble polymers the resulting fibers are also water soluble and as mentioned above could be easily dissolved by washing.

WO 2008/049397 discloses the electrospinning using aqueous solution including polyelectrolytes of opposite charge.

But none of these fibers disclosed provides fluid-absorption and retention properties.

Therefore it is an object of the present invention to provide water-absorbing fibers (SAP fibers) in the micro-or nanometer scale by electrospinning with a high surface area and high fluid absorbency and high retention properties.

Furthermore it is an object of the present invention to provide an electrospinning method for producing SAP fibers.

It is also an object of the present invention to provide hygiene products, fluid-absorbent articles with improved fluid absorption and retention properties.

The object is achieved by a process for producing SAP fibres comprising the steps of electrospinning a solution, especially an aqueous solution, of at least one water-soluble polymer and at least one crosslinking agent and crosslinking the fibres.

Whereas it is preferred that the at least one water-soluble polymer is at least partially neutralized. The degree of neutralization is between 10 to 85 mol %, preferably between 30 to 60 mol %.

After electrospinning the resulting fibers are crosslinked by activating the crosslinking agent e.g. by heating for thermal sensitive crosslinking agents, or by UV light, pH-changes or redox, for other crosslinking agents. If using thermal sensitive crosslinking agents the fibres after electrospinning are heated to a temperature of 60 to 220° C., preferably 90 to 200° C., more preferably 110 to 180° C., most preferably 120 to 140° C., preferentially 125 to 135. Whereas the heating is performed for at least 10 min, preferably 30 to 90 min, more preferably 45 to 75 min, most preferably 55 to 65 min.

During the electrospinning, the fibers are collected by a substrate sheet, such as a nonwoven sheet, or an aluminium foil sheet, or substrates of silica treated paper or other suitable material. The substrate is necessary for anti-charging the fibres and to avoid distribution of the fibers throughout the chamber, where the spinning is performed, which will cause disruption of the spinning process.

To activate the heat sensitive crosslinking agent the heating could be performed by different methods one suitable method is to place the fibers on a tray, e.g. a metal sheet or any other suitable sheet and put this tray into an oven at a temperature and a time period suitable for activating the respective crosslinking agent as. Afterwards the fibers were removed from the substrate.

In case the substrate is resistant to the heat applied the fibers are not removed from the substrate and the substrate with the fibres is put into the oven.

Suitable polymers may be basic or acidic or a mixture thereof. Whereas a basic polymer typically containing amino or guanidine groups as e.g. poly(vinylamine), and an acidic polymer, e.g. the water soluble poly-acrylic acid are prepared by polymerizing a monomer of the group of ethylenically unsaturated carboxylic acids such as acrylic acid, methacrylic acid, maleic acid, and itaconic acid. Particularly preferred monomers are acrylic acid and methacrylic acid. Very particular preference is given to acrylic acid.

Further suitable monomers are, for example, ethylenically unsaturated sulfonic acids such as vinylsulfonic acid, styrenesulfonic acid and 2-acrylamido-2-methyl-propane-sulfonic acid (AMPS).

Ethylenically unsaturated carboxylic acid and carboxylic acid anhydride monomers useful in the inventive waterabsorbing fibers include acrylic acid, methacrylic acid, ethacrylic acid, α-chloroacrylic acid, α-cyanoacrylic acid, β-methylacrylic acid (crotonic acid), α-phenylacrylic acid, β-acryloxy-propionic acid, sorbic acid, α-chlorosorbic acid, angelic acid, cinnamic acid, p-chlorocinnamic acid, β-stearylacrylic acid, itaconic acid, citraconic acid, mesaconic acid, glutaconic acid, aconitic acid, maleic acid, fumaric acid, tricarboxyethylene, and maleic anhydride.

Ethylenically unsaturated sulfonic acid monomers include aliphatic or aromatic vinyl sulfonic acids, such as vinylsulfonic acid, allyl sulfonic acid, vinyl toluene sulfonic acid, styrene sulfonic acid, acrylic and methacrylic sulfonic acids, such as sulfoethyl acrylate, sulfoethyl methacrylate, sulfopropyl acrylate, sulfopropyl methacrylate, 2-hydroxy-3methacryloxypropyl sulfonic acid, and 2-acrylamide-2methylpropane sulfonic acid.

As set forth above, polymerization of such monomers, or mixtures thereof, if present, most commonly is performed by free radical processes.

The resulting polymers such as polyacrylic acid, hydrolyzed starchacrylonitrile graft copolymers, starch-acrylic acid graft copolymers, saponified vinyl acetate-acrylic esters copolymers, hydrolyzed acrylonitrile copolymers, hydrolyzed acrylamide copolymers, ethylene-maleic anhydride copolymers, isobutylene-maleic anhydride copolymers, poly(vinylsulfonic acid), poly(vinylphosphonic acid), poly(vinylphosphoric acid), poly(vinylsulfuric acid), sulfonated polystyrene, poly(aspartic acid), poly(lactic acid), and mixtures thereof, whereas polyacrylic acid for electrospinning are dissolved, preferably in water.

The polymer solutions have typically been partially neutralized. Neutralization is preferably carried out at the monomer stage. This is typically done by mixing in the neutralizing agent as an aqueous solution or preferably also as a solid. The degree of neutralization is preferably from 10 to 85 mol %, for “acidic” polymer gels more preferably from 30 to 60 mol %, most preferably from 35 to 55 mol %, and for “neutral” polymer gels more preferably from 65 to 80 mol %, most preferably from 70 to 75 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts, such as the salt of triethanolamine. Particularly preferred alkali metals are sodium and potassium, but very particular preference is given to sodium hydroxide, sodium carbonate or sodium hydrogencarbonate and also mixtures thereof.

However, it is also possible to carry out neutralization after the polymerization, at the stage of the polymer solution. It is also possible to neutralize up to 40 mol %, preferably 10 to 30 mol % and more preferably 15 to 25 mol % of the acid groups before the polymerization by adding a portion of the neutralizing agent actually to the monomer solution and setting the desired final degree of neutralization only after the polymerization.

The solutions suitable for electrospinning according to the present invention also contain crosslinkers to crosslink the resulting SAP-fibers to a sufficient extent such that the polymer fibers are water insoluble. Preferably the surface crosslinking agent is water soluble and possesses sufficient reactivity with the polymer fiber such that crosslinking occurs in a controlled fashion, at a temperature about 60 to 220° C., more preferably 110 to 180° C.

Crosslinking renders the fibers substantially water insoluble, and, in part, serves to determine the absorption capacity of the fibers. For use in absorption applications, a fiber is lightly crosslinked, i.e., the amount of crosslinker is less than about 7% by weight, preferably the amount of crosslinker is from 0.05 to 5.0% by weight, more preferably from 0.1 to 1% by weight, most preferably from 0.3 to 0.6% by weight, based in each case on the total weight of (non-neutralized) polymer. The amount of crosslinker in % by weight is the quotient of the weight of crosslinker used and the weight of non-neutralized polymer.

Suitable crosslinkers are compounds having groups which can form at least two covalent bonds within the polymers. Such groups are, for example functional groups which can form covalent bonds with the acid, e.g. carboxylate groups of the polymer.

Suitable compounds are, for example, polyfunctional amines, polyfunctional amidoamines, polyfunctional epoxides, as described in EP 0 083 022 A2, EP 0 543 303 A1 and EP 0 937 736 A2, di- or polyfunctional alcohols, as described in DE 33 14 019 A1, DE 35 23 617 A1 and EP 0 450 922 A2, or β-hydroxyalkylamides, as described in DE 102 04 938 A1 and U.S. Pat. No. 6,239,230.

Additionally described as suitable crosslinkers are cyclic carbonates in DE 40 20 780 C1, 2-oxazolidone and its derivatives, such as 2-hydroxyethyl-2-oxazolidone in DE 198 07 502 A1, bis- and poly-2-oxazolidinones in DE 198 07 992 C1, 2-oxotetrahydro-1,3-oxazine and its derivatives in DE 198 54 573 A1, N-acyl-2-oxazolidones in DE 198 54 574 A1, cyclic ureas in DE 102 04 937 A1, bicyclic amide acetals in DE 103 34 584 A1, oxetanes and cyclic ureas in EP 1 199 327 A2 and morpholine-2,3-dione and its derivatives in WO 2003/031482 A1.

Preferred crosslinkers are ethylene carbonate, ethylene glycol diglycidyl ether, reaction products of polyamides with epichlorohydrin, and mixtures of propylene glycol and 1,4-butanediol.

Very particularly preferred crosslinkers are 2-hydroxyethyl-2-oxazolidin, oxazolidin-2-one, 1,3-propanediole and polyethylene glycol diglycidyl ether. Whereas a mixture of 2-hydroxyethyl-2-oxazolidin and 1,3-propanediol with a 50/50 weight ratio is most particularly preferred.

Whereas crosslinking agents especially suited for acidic polymers are, e.g. polyhydroxy compounds, such as glycol and glycerol, metal salts, quaternary ammonium compounds, multifunctional epoxy compounds, alkylene carbonate, such as ethylene carbonate or propylene carbonate, polyaziridine, such as 2,2-bishydroxymethyl butanol tris[3-(1-aziridine propionate)], haloepoxy, such as epichlorhydrine, polyamine, such as ethylenediamin, polyisocyanate, such as 2,4-toluene diisocyanate.

Crosslinking agents especially suited for basic polymers are dihalides and disulfonate esters, e.g. compounds of the formula Y—(CRJ)p-Y, wherein R is —H, -alkyl or -aryl, J is 2, p is a number from 2 to 12, and Y is halo, preferably bromo, tosylate, mesylate or other alkyl or aryl sulfonate esters, multifunctional aziridines, multifunctional aldehydes, e.g. glutaraldehyde, trioxane, paraformaldehyde, terephtaldehyde, malonaldehyde, and glyoxal, and acetals and bisulfites thereof, halohydrins, as epichlohydrine, multifunctional epoxy compounds, e.g. ethylene glycol diglycidyl ether, bisphenol A diglycidyl ether, and bisphenol F diglicodyl ether, multifunctional carboxylic acids and esters, acid chlirides and anhydrides derives therfrom, e.g. di- and polycarboxylic acids containing 2 to 12 carbon atoms, and the methyl and ethyl esters, acid chlorides, and anhydrides derives therefrom, such as oxalic acid, adipic acid, succinic acid, dodecanoic acid, malonic acid, and glutaric acid, and esters, and anhydrides, and acid chlorides derived therefrom, organic titanates, such as TYZOR AA, available from E. DuPont de Nemours, Wilmington, Del., melamine resins, such as Cymel resins available from Cytec industries, Wayne, N.J., hydroxymethyl ureas, such as N,N′-dihydroxymethyl-4,5-dihydroxyethylene urea, multifunctional isocyanates such as toluene diisocyanate, isophorone diisocanate, methylene diisocyanate, xylene diisocyanate, and hexamethylene diisocyanate.

For the electro-spinning process it is important that the polymer concentration in the aqueous medium is between 5% and 60%, preferably between 10% and 50%, more preferably between 15 to 30%.

When exclusively water is used as the solvent, a surfactant may be advantageously added. This improve the electrospinning process and the fiber properties. Suitable sufactants are surfactants comprising e.g. (oligo)oxyalkene groups, or carbohydrate groups or amine oxides.

The polymer solution according to the invention can be electrospun using any methods known to those skilled in the art.

The distance between the cannula and the counterelectrode functioning as the collector, and the voltage between the electrodes, is preferably adjusted in such a way that an electrical field of 1 to 6 kV/cm, preferably from 1.5 to 5 kV/cm, more preferably from 2 to 4.5 kV/cm and most preferably from 2.5 to 4 kV/cm forms between the electrodes. Good results are achieved especially when the internal diameter of the cannula is from 50 to 500 μm.

A suitable electrospinning apparatus comprises a syringe which is provided at its tip with a capillary die connected to one pole of a voltage source and is for accommodating the inventive solution. Good results are achieved when the internal diameter of the capillary die is from 50 to 500 μm. Opposite the exit of the capillary die, at a distance of about 20 cm, preferably of about 16 cm, more preferably of about 14 cm, most preferably of about 13 cm, is arranged a counterelectrode, e.g. a square counterelectrode, or collecting electrode connected to the other pole of the voltage source, which functions as the collector for the fibers formed. During the operation of the apparatus, a voltage between 0 kV and 82 kV is set at the electrodes in such a way that an electrical field of preferably from 1 to 6 kV/cm, more preferably from 1.5 to 5 kV/cm, preferentially from 2 to 4.5 kV/cm and most preferably from 2.5 to 4 kV/cm forms between the electrodes. Owing to the electrostatic charge a material flow directed toward the counterelectrode forms, which solidifies on the way to the counterelectrode with fiber formation, as a consequence of which fibers with diameters in the micro- and nanometer range are deposited on the counterelectrode.

Also suitable are electrospinning apparatus' e.g. Nanospider® which do not use jets or capillaries for the production of fibres, but a rotating drum partially dipped in the polymer solution to be spun. The drum is rotated so that a thin film of polymer is created on its surface. Opposite to the drum, at a distance of about 20 cm, preferably of about 16 cm, more preferably of about 14 cm, most preferably of about 11 cm, a counterelectrode is arranged, e.g. a square counterelectrode, or collecting electrode connected to the other pole of the voltage source, which functions as the collector for the fibers formed.

An electrical field of preferably from 1 to 6 kV/cm, more preferably from 1.5 to 5 kV/cm, preferentially from 2 to 4.5 kV/cm and most preferably from 2.5 to 4 kV/cm is formed between the electrodes.

Based on the electric field at the center of the rotating drum, which is nearest to the counterelectrode many focal points of Taylor cones are formed, which subsequently leads to a flow of matter towards the counterelectrode, the fiber spinning.

Generally a temperature range for spinning is chosen of 10 to 30 ° C., preferably 15 to 25 ° C., more preferably 21 to 27° C. and a humidity range of 10 to 45% RH, preferably 20 to 35% RH.

With the aforementioned apparatus, in accordance with the invention, a solution of at least one essentially water-soluble polymer and of at least one crosslinker an aqueous medium is electrospun.

After electro-spinning, the crosslinker in the polymer fibers are thermally activated.

Therefore the fibers are heated to activate crosslinking agents usually without any extra drying step as an extra drying step is not necessary because of the diameter in the micro- or nanometer range and the very large surface area of the fibers.

When thermally activating the crosslinking agents, preferred heating temperatures are in the range of 60 to 220° C., preferably 90 to 200° C., more preferably 110 to 150° C., most preferably 120 to 140° C., preferentially 125 to 135. The preferred heating time at this temperature is preferably at least 10 minutes, more preferably at least 20 minutes, most preferably at least 45 minutes, and typically at most 60 minutes.

After heating process, the moisture content in fibers is preferably 0.5 to 15% by weight, more preferably 1 to 10% by weight, most preferably 3 to 5% by weight, the residual moisture content being determined by EDANA recommended test method No. WSP 230.2-5 “Moisture Content”.

In the case of too high a residual moisture content, the dried polymer fibers have too low a glass transition temperature T_{g} and can be processed further only with difficulty. In the case of too low a residual moisture content, the dried polymer gel is too brittle and, in the subsequent comminution steps, undesirably large amounts of polymer fibers with an excessively low fiber length are obtained.

It is preferred to cool the polymer fibers after thermal activation. The cooling is preferably carried out in coolers (moisture controlled ovens, set at room temperature) at a temperature range from 18 to 25° C.

The fibers combine a high water resistance with a good mechanical stability. Furthermore the SAP fibers according to the present invention absorb liquids quickly, provide a good fluid permeability and conductivity into and through the SAP fiber and have high gel strength such that the hydrogel formed from the SAP fibers does not deform or flow under an applied pressure or stress.

The diameter of the inventive fibers is preferably less than 3 μm, preferably less than 2 μm, more preferably less than 1 μm, particularly less than 500 nm, very particularly less than 300 nm. The length of the fibers depends upon the intended use and is generally from 50 μm up to several kilometres.

Water-absorbing polymer fibres with a centrifuge retention capacity (CRC) of at least 5 g/g, a fiber diameter of 0.3 to 2 μm, a degree of neutralization of 10 to 80 mol % and an amount of crosslinker not greater than 2.0 weight %, based on the non-neutralized polymer are preferred.

More preferred are water-absorbing polymer fibres with a centrifuge retention capacity (CRC) of at least 8 g/g, a fiber diameter of 0.3 to 2 μm, a degree of neutralization of 10 to 80 mol % and an amount of crosslinker not greater than 1.2 weight %, based on the non-neutralized polymer.

To further improve the properties, the polymer fibers can be coated and/or remoisturized.

Suitable coatings for controlling the acquisition behavior and improving the permeability (SFC or GBP) are, for example, inorganic inert substances, such as water-insoluble metal salts, organic polymers, cationic polymers and polyvalent metal cations. Suitable coatings for improving the color stability are, for example reducing agents and anti-oxidants. Suitable coatings for dust binding are, for example, polyols.

Suitable inorganic inert substances are silicates such as montmorillonite, kaolinite and talc, zeolites, activated carbons, polysilicic acids, magnesium carbonate, calcium carbonate, calcium phosphate, barium sulfate, aluminum oxide, titanium dioxide and iron(II) oxide. Preference is given to using polysilicic acids, which are divided between precipitated silicas and fumed silicas according to their mode of preparation. The two variants are commercially available under the names Silica FK, Sipernat®, Wessalon® (precipitated silicas) and Aerosil® (fumed silicas) respectively. The inorganic inert substances may be used as dispersion in an aqueous or water-miscible dispersant or in substance.

When the fluid-absorbent polymer fibers are coated with inorganic inert substances, the amount of inorganic inert substances used, based on the fluid-absorbent polymer fibers, is preferably from 0.05 to 5% by weight, more preferably from 0.1 to 1.5% by weight, most preferably from 0.3 to 1% by weight.

Suitable organic polymers are polyalkyl methacrylates or thermoplastics such as polyvinyl chloride, waxes based on polyethylene, polypropylene, polyamides or polytetrafluoro-ethylene. Other examples are styrene-isoprene-styrene block-copolymers or styrene-butadiene-styrene block-copolymers.

Suitable cationic polymers are polyalkylenepolyamines, cationic derivatives of polyacrylamides, polyethyleneimines and polyquaternary amines.

Polyquaternary amines are, for example, condensation products of hexamethylenedi-amine, dimethylamine and epichlorohydrin, condensation products of dimethylamine and epichlorohydrin, copolymers of hydroxyethylcellulose and diallyldimethylammo-nium chloride, copolymers of acrylamide and α-methacryloyloxyethyltrimethylammo-nium chloride, condensation products of hydroxyethylcellulose, epichlorohydrin and trimethylamine, homopolymers of diallyldimethylammonium chloride and addition products of epichlorohydrin to amidoamines. In addition, polyquaternary amines can be obtained by reacting dimethyl sulfate with polymers such as polyethyleneimines, copolymers of vinylpyrrolidone and dimethylaminoethyl methacrylate or copolymers of ethyl methacrylate and diethylaminoethyl methacrylate. The polyquaternary amines are available within a wide molecular weight range.

However, it is also possible to generate the cationic polymers on the fiber surface, either through reagents which can form a network with themselves, such as addition products of epichlorohydrin to polyamidoamines, or through the application of cationic polymers which can react with an added crosslinker, such as polyamines or polyimines in combination with polyepoxides, polyfunctional esters, polyfunctional acids or poly-functional (meth)acrylates.

It is possible to use all polyfunctional amines having primary or secondary amino groups, such as polyethyleneimine, polyallylamine and polylysine. The liquid sprayed by the process according to the invention preferably comprises at least one polyamine, for example polyvinylamine or a partially hydrolyzed polyvinylformamide.

The cationic polymers may be used as a solution in an aqueous or water-miscible solvent, as dispersion in an aqueous or water-miscible dispersant or in substance. When the fluid-absorbent polymer fibers are coated with a cationic polymer, the use amount of cationic polymer based on the fluid-absorbent polymer particles is usually not less than 0.001% by weight, typically not less than 0.01% by weight, preferably from 0.1 to 15% by weight, more preferably from 0.5 to 10% by weight, most preferably from 1 to 5% by weight.

Suitable polyvalent metal cations are Mg²⁺, Ca²⁺, Al³⁺, Sc³⁺, Ti⁴⁺, Mn²⁺, Fe^{2+/3+}, Co²⁺, Ni²⁺, Ce^{+/2+}, Zn²⁺, Y³⁺, Zr⁴⁺, Ag⁺, La³⁺, Ce⁴⁺, Hf⁴⁺]and Au^{+/3+}; preferred metal cations are Mg²⁺, Ca²⁺, Al³⁺, Ti⁴⁺, Zr⁴⁺ and La³⁺; particularly preferred metal cations are Al³⁺, Ti⁴⁺ and Zr⁴⁺. The metal cations may be used either alone or in a mixture with one another. Suitable metal salts of the metal cations mentioned are all of those which have a sufficient solubility in the solvent to be used.

Particularly suitable metal salts have weakly complexing anions, such as chloride, hydroxide, carbonate, nitrate and sulfate. The metal salts are preferably used as a solution or as a stable aqueous colloidal dispersion. The solvents used for the metal salts may be water, alcohols, dimethylformamide, dimethyl sulfoxide and mixtures thereof. Particular preference is given to water and water/alcohol mixtures, such as water/methanol, water/isopropanol, water/1,3-propanediole, water/1,2-propandiole/1,4-butanediole or water/propylene glycol.

When the fluid-absorbent polymer fibers are coated with a polyvalent metal cation, the amount of polyvalent metal cation used, based on the fluid-absorbent polymer particles, is preferably from 0.05 to 5% by weight, more preferably from 0.1 to 1.5% by weight, most preferably from 0.3 to 1% by weight.

Suitable reducing agents are, for example, sodium sulfite, sodium hydrogensulfite (sodium bisulfite), sodium dithionite, sulfinic acids and salts thereof, ascorbic acid, sodium hypophosphite, sodium phosphite, and phosphinic acids and salts thereof. Preference is given, however, to salts of hypophosphorous acid, for example sodium hypophos-phite, salts of sulfinic acids, for example the disodium salt of 2-hydroxy-2-sulfinato-acetic acid, and addition products of aldehydes, for example the disodium salt of 2-hy-droxy-2-sulfonatoacetic acid. The reducing agent used can be, however, a mixture of the sodium salt of 2-hydroxy-2-sulfinatoacetic acid, the disodium salt of 2-hydroxy-2-sulfonatoacetic acid and sodium bisulfite. Such mixtures are obtainable as Bruggolite® FF6 and Bruggolite® FF7 (Bruggemann Chemicals; Heilbronn; Germany).

The reducing agents are typically used in the form of a solution in a suitable solvent, preferably water. The reducing agent may be used as a pure substance or any mixture of the above reducing agents may be used.

When the fluid-absorbent polymer fibers are coated with a reducing agent, the amount of reducing agent used, based on the fluid-absorbent polymer particles, is preferably from 0.01 to 5% by weight, more preferably from 0.05 to 2% by weight, most preferably from 0.1 to 1% by weight.

Suitable polyols are polyethylene glycols having a molecular weight of from 400 to 20000 g/mol, polyglycerol, 3- to 100-tuply ethoxylated polyols, such as trimethylol-propane, glycerol, sorbitol and neopentyl glycol. Particularly suitable polyols are 7- to 20-tuply ethoxylated glycerol or trimethylolpropane, for example Polyol TP 70® (Perstorp AB, Perstorp, Sweden). The latter have the advantage in particular that they lower the surface tension of an aqueous extract of the fluid-absorbent polymer fibers only insignificantly. The polyols are preferably used as a solution in aqueous or water-miscible solvents.

When the fluid-absorbent polymer fibers are coated with a polyol, the use amount of polyol, based on the fluid-absorbent polymer particles, is preferably from 0.005 to 2% by weight, more preferably from 0.01 to 1% by weight, most preferably from 0.05 to 0.5% by weight.

The coating is preferably performed by spaying the respective solutions on the fibers.

The fluid-absorbing polymer fibers have a centrifuge retention capacity (CRC) of at least 5 g/g, typically at least 8 g/g, preferably at least 15 g/g, preferentially more preferably at least 20 g/g, more preferably at least 23 g/g, most preferably at least 26 g/g. The centrifuge retention capacity (CRC) of the fluid-absorbing polymer fibers is typically less than 60 g/g. The centrifuge retention capacity (CRC) is determined by EDANA recommended test method No. WSP 241.2-5 “Centrifuge Retention Capacity”.

The present invention is also related to fluid absorbent articles comprising SAP-fibres according to the invention. Fluid absorbent articles are understood to mean, for example, incontinence pads and incontinence pants for adults, or diapers for babies.

Furthermore the invention is directed to a fluid absorbent article comprising a layer containing water-absorbing fibres (SAP fibres), whereas the layer could comprise fluid-absorbent polymer fibers according to the present invention or mixtures of the inventive fibres and other fibres. The layer preferably contains SAP fibers in an amount of about 0.1% to 100% by total weight of fibyes.

For example, the resulting fluid absorbent article may have the following construction:
(A) an upper liquid-pervious topsheet
(B) a lower liquid-impervious layer
(C) a layer of water-absorbing fibres or mixtures of water-absorbing fibres with fluff, between topsheet (A) and layer (B),
(D) optionally a tissue layer immediately above and below the layer of water-absorbing fibres (C) and
(E) optionally an absorption and distribution layer between topsheet (A) and the layer of water-absorbing fibres (C).

The thickness of the layer of water-absorbing fibres or mixtures of water-absorbing fibres with fluff can be varied. For example, the water-absorbing layer (C) may have less material, for example, in the outer region. Cutouts and channels are likewise possible.

Examples of fibers to be mixed with the inventive SAP fibres include cellulose fibers such as fluff pulp and cellulose of the cotton type. The materials (soft- or hardwoods), production processes such as chemical pulp, semichemical pulp, chemothermomechanical pulp (CTMP) and bleaching processes are not particularly restricted. For example, natural cellulose fibers such as cotton, flax, silk, wool, jute, ethylcellulose and cellulose acetate are used.

Suitable synthetic fibers are produced from polyvinyl chloride, polyvinyl fluoride, polytetrafluoroethylene, polyvinylidene chloride, polyacrylic compounds such as ORLON®, polyvinyl acetate, polyethyl vinyl acetate, soluble or insoluble polyvinyl alcohol. Examples of synthetic fibers include thermoplastic polyolefin fibers, such as polyethylene fibers (PULPEX®), polypropylene fibers and polyethylene-polypropylene bicomponent fibers, polyester fibers, such as polyethylene terephthalate fibers (DACRON® or KODEL®), copolyesters, polyvinyl acetate, polyethyl vinyl acetate, polyvinyl chloride, polyvinylidene chloride, polyacrylics, polyamides, copolyamides, polystyrene and copolymers of the aforementioned polymers and also bicomponent fibers composed of polyethylene terephthalate-polyethylene-isophthalate copolymer, polyethyl vinyl acetate/polypropylene, polyethylene/polyester, polypropylene/polyester, copolyester/polyester, polyamide fibers (nylon), polyurethane fibers, polystyrene fibers and polyacrylonitrile fibers. Preference is given to polyolefin fibers, polyester fibers and their bicomponent fibers. Preference is further given to thermally adhesive bicomponent fibers composed of polyolefin of the core-sheath type and side-by-side type on account of their excellent dimensional stability following fluid absorption.

The fiber cross section may be round or angular, or else have another shape, for example like that of a butterfly.

The synthetic fibers mentioned are preferably used in combination with thermoplastic fibers. In the course of the heat treatment, the latter migrate to some extent into the matrix of the fiber material present and so constitute bond sites and renewed stiffening elements on cooling. In addition, the addition of thermoplastic fibers means that there is an increase in the present pore dimensions after the heat treatment has taken place. This makes it possible, by continuous metered addition of thermoplastic fibers during the formation of the absorbent layer, to continuously increase the fraction of thermoplastic fibers in the direction of the topsheet, which results in a similarly continuous increase in the pore sizes. Thermoplastic fibers can be formed from a multitude of thermoplastic polymers which have a melting point of less than 190° C., preferably in the range from 75° C. to 175° C. These temperatures are too low for damage to the cellulose fibers to be likely.

Lengths and diameters of the above-described synthetic fibers are not particularly restricted, and generally any fiber from 1 to 200 mm in length and from 0.1 to 100 denier (gram per 9000 meters) in diameter may preferably be used. Preferred thermoplastic fibers are from 3 to 50 mm in length, particularly preferred thermoplastic fibers are from 6 to 12 mm in length. The preferred diameter for the thermoplastic fibers is in the range from 1.4 to 10 decitex, and the range from 1.7 to 3.3 decitex (gram per 10 000 meters) is particularly preferred. The form of the fibers may vary; examples include woven types, narrow cylindrical types, cut/split yarn types, staple fiber types and continuous filament fiber types.

Suitable hydrophilic fibers include for example cellulose fibers, modified cellulose fibers, rayon, polyester fibers, for example polyethylene terephthalate (DACRON®), and hydrophilic nylon (HYDROFIL®). Suitable hydrophilic fibers may also be obtained by hydrophilizing hydrophobic fibers, for example the treatment of thermoplastic fibers obtained from polyolefins (e.g. polyethylene or polypropylene, polyamides, polystyrenes, polyurethanes, etc.) with surfactants or silica. However, for reasons of cost and availability, cellulose fibers are preferred.

The liquid-impervious topsheet (A) is a layer in direct contact with the skin. The material for this purpose consists of customary synthetic or semisynthetic fibers or films of polyester, polyolefins, rayon or natural fibers such as cotton. In the case of nonwoven materials, the fibers should generally be bound by binders such as polyacrylates. Preferred materials are polyester, rayon and blends thereof, polyethylene and polypropylene. Examples of liquid-pervious layers are described in WO 99/57355 A1, EP 1 023 883 A2.

The liquid-impervious layer (B) generally consists of a film of polyethylene or polypropylene. A nonwoven may be laminated onto the layer (B) for better tactile properties on the outside.

Absorption and distribution layers (E) are typically produced from nonwovens which have very good wicking action, in order to absorb and to distribute the liquid rapidly. They also improve rewetting. When pressure on the diaper causes the water-absorbing composite to release liquid, the absorption and distribution layer (E) prevents this liquid from coming into contact with the skin of the user.

Suitable nonwovens are thermally bonded or resin-bonded fibers based on polypropylene and/or polyester fibers with a basis weight of 25 to 70 gms, for example Curadis®, Curadis® EPS, Curadis® ATP and Curadis® RB (Albis SPA, IT).

Further suitable absorption and distribution layers (E) are obtained by “airthroughbonding” and are obtainable under the Acquitex® (Texus SPA, IT) and Dry Web® (Libeltex BVBA, NL) trademarks.

Methods

Solid Content

The solids content within the solution is determined gravimetrically by means of a Mettler Toledo HR73 halogen moisture analyzer, by heating approx. 1 ml of the sample to 200° C. within 2 minutes and drying the sample to constant weight and then weighing it.

Size of the Fibers

The size, i.e. the diameter and the length of the fibers, is determined by evaluating electron micrographs (using a Scanning Electronic Microscope (SEM) to determine the fiber diameters).

Centrifuge Retention Capacity (CRC)

The centrifuge retention capacity of the fluid-absorbent polymer particles is determined by the EDANA recommended test method No. WSP 241.2-5 “Centrifuge Retention Capacity”, wherein for higher values of the centrifuge retention capacity larger tea bags have to be used due to bursting of the tea-bag upon hydration.

Moisture Content

The moisture content of the fluid-absorbent polymer particles is determined by the EDANA recommended test method No. WSP 230.2-5 “Moisture Content”.

Residual Monomers

The level of residual monomers in the fluid-absorbent polymer particles is determined by the EDANA recommended test method No. WSP 210.2-5 “Residual Monomers”.

The EDANA test methods are obtainable, for example, from the EDANA, Avenue Eugene Plasky 157, B-1030 Brussels, Belgium.

The following examples illustrate the preparation of the SAP-fibers of the present invention.

For the examples a commercial available poly-acrylic acid (PAA) named Sokalan®PA 110S (about 35% of polymer, available from , BASF SE, Carl-Bosch-Strasse 38, 6703, Ludwigshafen, Germany) is diluted to a suitable concentration with deionic water, and the resulting solution is neutralized to designed degree levels. Further a selected crosslinking agent is dissolved into the solution. This preparation should unless stated otherwise, be carried out at an ambient temperature of 23±2° C. and an atmospheric humidity of 50±10%.

### EXAMPLE 1

A 20% PAA solution is prepared made by mixing 228.57 grams of 35% PAA (poly-acrylic acid) solution (Sokalan®PA 110S, BASF SE, Carl-Bosch-Strasse 38, 6703, Ludwigshafen, Germany) with 171.43 grams of de-ionic water by using of a stir plate with a stir bar for 30 minutes.

### EXAMPLE 2

A Heonon/PDO mixture (50/50% by weight, available from BASF SE, Ludwigshafen, Germany) is used as a crosslinker. The crosslinker is a mixture of 2-hydroxyethyl-2-oxazolidon (Heonon) and 1,3-propanediole (PDO) with 50/50 weight ratio.

0.03 grams of Heonon/PDO mixture (as a crosslinker) are added to 50 grams of example 1, and stirred about 30 minutes with a stir bar. The amount of crosslinker is calculated as: 0.03 g crosslinker/(20% PAA solution×50 g)=0.03 g/10 g=0.3 wt %

### EXAMPLE 3

0.04 grams of Heonon/PDO mixture (as a crosslinker) are added to 50 grams of example 1, and stirred about 30 minutes with a stir bar.

### EXAMPLE 4

0.06 grams of Heonon/PDO mixture (as a crosslinker) are added to 50 grams of example 1, and stirred about 30 minutes with a stir bar.

### EXAMPLE 5

0.10 grams of Heonon/PDO mixture (as a crosslinker) are added to 50 grams of example 1, and stirred about 30 minutes with a stir bar.

### EXAMPLE 6 (INVENTIVE)

50 grams of example 1 are mixed with 6.67 grams of Sodium Hydroxide Solution Certified 50/w/w (50/50 sodium hydroxide/water weight ratio, available from Fisher Scientific, 3970 Johns Creek Ct., Suit 500, Suwanee, Ga. 30024, USA) and stirred for 60 minutes on stir plate with a stir bar. Small air bubbles are seen throughout the solution, so the solution is allowed to sit until all of the air bubbles are dissipated. The degree of neutralization (DN) of the PAA solution is 30%.

0.04 grams of Heonon/PDO mixture (as a crosslinker) are added to the DN 30% PAA solution, and stirred about 30 minutes with a stir bar.

### EXAMPLE 7 (INVENTIVE)

0.06 grams of Heonon/PDO mixture (as a crosslinker) are added to a DN 30% PAA solution according to example 6, and stirred about 30 minutes with a stir bar.

### EXAMPLE 8 (INVENTIVE)

50 grams of example 1 are mixed with 11.11 grams of Sodium Hydroxide Solution Certified 50/w/w (50/50 sodium hydroxide/water weight ratio, available from Fisher Scientific, 3970 Johns Creek Ct., Suit 500, Suwanee, Ga. 30024, USA) and stirred for 60 minutes on stir plate with a stir bar. Small air bubbles are seen throughout the solution. Therefore the solution is allowed to sit until all of the air bubbles have dissipated. The degree of neutralization (DN) of the resulting PAA solution is 50%.

0.06 grams of Heonon/PDO mixture (as a crosslinker) are added to the DN 50% PAA solution, and stirred about 30 minutes with a stir bar.

### EXAMPLE 9 (INVENTIVE)

0.04 grams of crosslinker Heonon/PDO are added to 50 grams of a DN 50% PAA solution according to example 8 and stirred about 30 minutes with a stir bar.

### EXAMPLE 10 (INVENTIVE)

0.03 grams of crosslinker Heonon/PDO are added to 50 grams of a DN 50% PAA solution according to example 8 and stirred about 30 minutes with a stir bar.

### EXAMPLE 11 (INVENTIVE) 0.02 grams of crosslinker Heonon/PDO are added to 50 grams of a DN 50% PAA solution according to example 8 and stirred about 30 minutes with a stir bar.

### EXAMPLE 12 (INVENTIVE)

0.12 grams of crosslinker Heonon/PDO are added to 50 grams of a DN 50% PAA solution according to example 8 and stirred about 30 minutes with a stir bar.

### EXAMPLE 13 (INVENTIVE)

0.15 grams of crosslinker Heonon/PDO are added to 50 grams of a DN 50% PAA solution according to example 8 and stirred about 30 minutes with a stir bar.

### EXAMPLE 14 (INVENTIVE)

0.20 grams of crosslinker Heonon/PDO are added to 50 grams of a DN 50% PAA solution according to example 8 and stirred about 30 minutes with a stir bar.

### EXAMPLE 15

0.30 grams of crosslinker Heonon/PDO are added to 50 grams of a DN 50% PAA solution according to example 8 and stirred about 30 minutes with a stir bar.

### EXAMPLE 16 (INVENTIVE)

50 grams of example 1 are mixed with 12.22 grams of Sodium Hydroxide Solution Certified 50/w/w (available from Fisher Scientific, 3970 Johns Creek Ct., Suit 500, Suwanee, Ga. 30024, USA) and stirred for 60 minutes on stir plate with a stir bar. Small air bubbles are seen throughout the solution. The solution is allowed to sit until all of the air bubbles have dissipated. The degree of neutralization (DN) of the PAA solution is 55% and then 0.03 grams of crosslinker Heonon/PDO are added into DN 55% PAA solution and stirred about 30 minutes with a stir bar.

### EXAMPLE 17

50 grams of a DN 50% PAA solution according to example 8 without any crosslinker is stirred for about 30 minutes with a stir bar.

### EXAMPLE 18 (INVENTIVE)

Denacol EX-810 (Nagase ChemteX Corporation Tasuno City Hyogo, Japan) is used as a crosslinker; 0.10 grams of Denacol EX-810 are added into 50 grams of a DN 50% PAA solution according to example 8 and stirred about 30 minutes with a stir bar.

### EXAMPLE 19 (INVENTIVE)

0.07 grams of Denacol EX-810 are added into 50 grams of a DN 50% PAA solution according to example 8 and stirred about 30 minutes with a stir bar.

### EXAMPLE 20 (INVENTIVE)

0.05 grams of Denacol EX-810 are added into 50 grams of a DN 50% PAA solution according to example 8 and stirred about 30 minutes with a stir bar.

The amount of crosslinker is calculated for each example, the results are listed in Table 1.

Electrospinning

The electrospinning was performed with an electrospinning spider NS LAB 200, commercial available from Elmarco s.r.o. V Horkach 76/18, 460 07, Liberec 9, Czech Republic.

For each solution (Examples 1 to 20) about 20 grams are poured into the Nanospider®'s low volume 20 ml spinning tube with small cylinder spinning electrode. The Tube is then placed into Nanospider® chamber with Elmarco's (anti-stable charge treated) nonwoven substrate. The cylinder in the tube is positioned 11-14 cm in a distance from the collecting electrode. Generally a temperature range for spinning is chosen to 18 to 28 ° C. range and humidity range of 18 to 45% RH. For the polymer used in Examples 1 to 20 the optimum conditions are a temperature range of 21 to 27 ° C. and humidity in the range of 20-35% RH.

Providing an electric field strength in the range of 3 to 5kv/cm the E-spun fibers are made and collected on the selected substrates.

The fibers are formed with the crosslinker 2-hydroxyethyl-2-oxazolidon (Heonon) and 1,3-propanediole (PDO)(50/50 weight ratio) solution are removed from the substrate used, as it is only stable up to 130° C., placed in an oven proof container and put into a 180° C. oven for 60 minutes to activate the crosslinker. The fibers formed with the crosslinker Denacol EX-810 solution are kept on the substrate. The substrate is placed on a metal sheet and put into a 130° C. oven for 60 minutes to activate the crosslinker. The fibers then removed from the substrate.

For each of the resulting fibres the CRC was measured according to the above mentioned method. The results are summarized in the following table:

TABLE 1
Results of the CRC measurements

| | | | | Amount | E-spun | |
|---|---|---|---|---|---|---|
| | PAA | Degree of | | of crosslinker | fiber size | CRC |
| Example | concentration % | neutralization % | crosslinker | wt % | (μm) | (g/g) |
| 1 | 20 | 0 | Heonon/PDO | 0 | 0.5 to 2.0 | 0 |
| 2 | 20 | 0 | Heonon/PDO | 0.3 | 1.0 to 2.0 | 4.3 |
| 3 | 20 | 0 | Heonon/PDO | 0.4 | 1.0 to 2.0 | 4 |
| 4 | 20 | 0 | Heonon/PDO | 0.6 | 1.0 to 2.0 | 3.7 |
| 5 | 20 | 0 | Heonon/PDO | 1 | 1.0 to 2.0 | 2.9 |
| 6 (inventive) | 20 | 30 | Heonon/PDO | 0.4 | 0.5 to 2.0 | 9.8 |
| 7 (inventive) | 20 | 30 | Heonon/PDO | 0.6 | 0.5 to 2.0 | 8.2 |
| 8 (inventive) | 20 | 50 | Heonon/PDO | 0.6 | 0.5 to 2.0 | 11.8 |
| 9 (inventive) | 20 | 50 | Heonon/PDO | 0.4 | 0.5 to 2.0 | 13.6 |
| 10 (inventive) | 20 | 50 | Heonon/PDO | 0.3 | 0.5 to 2.0 | 15.9 |
| 11 (inventive) | 20 | 50 | Heonon/PDO | 0.2 | 0.3 to 2.0 | 15.4 |
| 12 (inventive) | 20 | 50 | Heonon/PDO | 1.2 | 0.5 to 2.0 | 8.3 |
| 13 (inventive) | 20 | 50 | Heonon/PDO | 1.5 | 0.5 to 2.0 | 6.7 |
| 14 (inventive) | 20 | 50 | Heonon/PDO | 2.0 | 0.5 to 2.0 | 5.9 |
| 15 | 20 | 50 | Heonon/PDO | 3.0 | 0.5 to 2.0 | 4.1 |
| 16 (inventive) | 20 | 55 | Heonon/PDO | 0.3 | 0.5 to 2.0 | 17.3 |
| 17 | 20 | 50 | Denacol | 0 | N/A | 0 |
| 18 (inventive) | 20 | 50 | Denacol | 1.0 | 0.5 to 2.0 | 15.0 |
| 19 (inventive) | 20 | 50 | Denacol | 0.7 | 0.6 to 2.0 | 20.7 |
| 20 (inventive) | 20 | 50 | Denacol | 0.5 | 0.4 to 2.0 | 23.0 |

1. A process for producing water-absorbing polymer fibres comprising the steps of
a) electrospinning a solution comprising at least one water-soluble polymer and at least one crosslinker and
b) crosslinking the fibres.

2. The process according to claim 1, wherein the at least one water soluble polymer is at least partially neutralized.

3. The process according to claim 1, wherein the crosslinker is activated after electrospinning.

4. The process according to claim 1, wherein the solution is aqueous and a polymer concentration in the aqueous medium is between 5% and 60%.

5. The process according to claim 2, wherein the a degree of neutralization is between 10 to 85 mol %, preferably between 30 to 75 mol %.

6. The process according to claim 1, wherein an amount of crosslinker is from 0.05 to 5.0% by weight, based on the non-neutralized polymer.

7. The process according to claim 1, wherein the crosslinker is activated by heat.

8. The process according to claim 7, wherein the temperature applied is between 60 to 220° C.

9. The process according to claim 1, wherein the at least one water soluble polymer is acidic.

10. The process according to claim 1, wherein the at least one water soluble polymer is basic.

11. The process according to claim 9, wherein the acidic water soluble polymer is polyacrylic acid.

12. The process according to claim 10, wherein the basic water soluble polymer is polyvinylamine.

13. Water-absorbing polymer fibres obtained by a process according to claim 1.

14. The fibres according to claim 13, which have a diameter not greater than 3 μm.

15. The fibres according to claim 13, which have a diameter not greater than 1 μm.

16. The fibres according to claim 13, which have a diameter not greater than 0.3 μm.

17. The fibres according to claim 13, which have a centrifuge retention capacity (CRC) of at least 8 g/g

18. The fibres according to claim 13, which have a centrifuge retention capacity (CRC) of at least 15 g/g

19. Water-absorbing polymer fibres having a centrifuge retention capacity (CRC) of at least 8 g/g, a fiber diameter of 0.3 to 2 μm, a degree of neutralization of 10 to 80 mol % and an amount of crosslinker not greater than 1.2 weight %, based on the non-neutralized polymer.

20. Water-absorbing polymer fibres having a centrifuge retention capacity (CRC) of at least 5 g/g, a fiber diameter of 0.3 to 2 μm, a degree of neutralization of 10 to 80 mol %, and an amount of crosslinker not greater than 2.0 weight %, based on the non-neutralized polymer.

21. A fluid absorbent article comprising fibres according to claim 13.

22. The fluid absorbent article according to claim 21, comprising a core containing about 0.1% to 100% by weight of the fibres.
